(19) United States
(12) Patent Application Publication
(10) Pub. No.: US 2004/0088221 A1
(43) Pub. Date: May 6, 2004

(54) System and method for computing measures of retailer loyalty

(76) Inventors: Gary M Katz, Northbrook, IL (US); Joni Elmore, Clearwater, FL (US); Laura Rangel, Orange, CA (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/451,845

(22) PCT Filed: Jan. 3, 2002
(86) PCT No.: PCT/US02/00479

(30) Foreign Application Priority Data
Jan. 30, 2001 (DE) 101-03-868.2

(51) Int. Cl. G06F 17/60

(52) U.S. Cl. 705/14

(57) ABSTRACT

The invention provides a system, computer program, and database for the accurate determination of customer loyalty by using a combination of shopping history data, household personal data, and demographic data (114a, 116). The invention defines a set of detailed measures of customer loyalty and computes values for those measures using unique combinations of data to provide better understanding of their customers shopping behavior (301,302, 303,304, 305.306,307), as a basis for rewarding or effectively incentivising desired behavior (416).

### BACKGROUND OF THE INVENTION

1. Field of the Invention

The present invention relates generally to systems and methods for providing incentives to customers to shop in retail stores.

2. Discussion of the Background

Most purchasing incentives are not targeted to specific households. One approach to improving retailer marketing has been to somehow measure a given customer's loyalty to a given retail store or manufacturer. Loyalty has been measured as the number of trips by the customer to the store in a predefined time period or as the amount spent by the customer at the store. This information could be derived from data collected on a customer's purchase history for purchases where the customer use a frequent shopper card having a card identification.

Customers' purchase history data has been used by computer systems to determine what coupons and/or other purchasing incentives to provide to the customer at the point of sale in a retail store.

The present inventors recognized that providing a detailed view of a given customer's loyalty to one retailer with respect to various products and product categories would be useful.

The present inventors also recognized that the loyalty of a particular customer to a particular store (or stores in a retail chain) could be quantified by comparing that customer's actual purchases in a given time period in that particular store (or any store in that retail chain) with an estimate of what the customer purchases in all stores selling the same types of goods.

The present inventors further recognized that factors statistically affecting such a measure of loyalty include the customer's and the customer's household's characteristics, such as age, income, and number of children.

The present inventors also recognized that quantified loyalty scores based upon the foregoing variables could provide both retailers and manufacturers with a better understanding of their customers' shopping behavior, and enable both retailers and manufacturers to better serve the needs of their customers and more effectively promote their products.

### SUMMARY OF THE INVENTION

Accordingly, it is an object of the present invention to provide retailers and manufacturers with a better understanding of their customers shopping behavior, so that they can respond appropriately.

Another object of the present invention is to provide a novel method and system for the accurate determination of customer loyalty by using a unique combination of shopping history data, household personal data, and demographic data.

Another object of the present invention is to define and use a new set of more detailed measures of customer loyalty that can be computed from this unique combination of data.

The above and other objects are achieved according to the present invention by providing a process, system, and computer program for a more accurate determination of customer loyalty using a combination of customer shopping history and personal/demographic data. The system of the present invention includes a marketing company computer system that communicates with at least one retailer computer system, a data company computer system, and a plurality of computer systems that provide customer address and census data. Each computer system has an associated database for storing at least some of the information necessary for the computation of household loyalty scores.

An important aspect of the present invention is the use of a household's shopping history at a given retailer as identified and collected, for example, in purchase transaction associated with frequent shopper card identifier. This information, which is stored in a database associated with a retailer's point-of-sale (POS) computer system, preferably includes the store's identification. In addition, the information stored in a database associated with a retailer's POS computer system preferably includes an identification corresponding to a household, and may use that field as primary key field. The identification is usually a frequent shopper card number. Associated in a record with each identification is a transaction date or date and time. Each such record also preferably includes the following data fields: universal product codes (UPCs), a scan price associated with each UPC code, the number of units associated with each UPC code (indicating the number of units having that UPC code that were purchased by the customer having that identification in the transaction having that date or date and time). However, in certain cases there may be more than a single entry for each UPC code in a single transaction record, e.g., when two items are purchased and scanned non-sequentially during the transaction. An additional example is when two units of a product are sold for an odd currency amount (e.g. 2 apples for 49 cents).

Another important aspect of the present invention is the type and sources of data used by the marketing company computer system and stored in its associated marketing company database. The marketing company database preferable includes records in which each record contains a key field including at least a unique identification. The unique identification preferably corresponds to the number on a frequent shopper card, a credit card, a check, or some other form of identification associated with an account. Alternatively, the unique identification could correspond to biographic data such as retinal eye scan data, facial characteristics data, or fingerprint data of the type used to identify a person. Each such record also includes data from one or more purchase transactions associated with the unique identification, as further described below.

The marketing company database also includes associations between records for which indicia indicates those records correspond to purchases made by individuals living in the same household. The associations may be based upon indicia including address data associated with each unique identification, data provided by frequent shopper card holders, or data provided by a third party data provider (e.g., a credit card company) indicating that the account numbers are associated with one household.

The marketing company database preferably also contains personal data for individuals and households (referred to herein as household personal data) such as income level (or levels), education level (or levels), number of children, age of children, ethnic code (or codes), etc.

Also included in the marketing company database are estimates of personal or total household spending (referred to herein as estimated household spending), as derived from data provided by outside sources, in which the estimates are for a given time period and for one or more given product categories. The one or more product categories include, for example, spending at grocery stores, spending on milk products, spending on baby food, spending on child-care products, spending on educational products, spending on ethnically oriented products, spending on meat products, spending on deli products, spending on perishable products, etc. These categories specifically include all categories of spending on food to be consumed either in the home or out of the home. For example, these categories include total food spending for food purchased for consumption in the home as well as food purchased in restaurants (i.e., for consumption out of the home).

Moreover, the marketing company database preferably includes data reflecting purchases in the retail store (or chain of retail stores) for household spending during at least one predetermined time period on various product categories, such as milk products, baby food, hair care, etc., as determined from the household's shopping history as recorded by a retailer's POS system. This data is referred to herein as actual household spending.

Moreover, the marketing company database preferably includes data reflecting the number of the trips by the consumer to the retailer in which the consumer purchases products in a specified category. In other words, the marketing company database preferably includes product- and/or product-category-specific customer recency and frequency data, referred to herein as actual household frequency data.

The actual household spending and actual household frequency data is collected and stored for one or more specified time periods. Some of the time periods may have special significance, and are referred to herein as holiday time periods. The marketing company database preferably includes data reflecting purchasing during holiday time periods. A holiday time period is a time period related to a holiday. Holiday time periods include retailer-defined time periods related to the Christmas holiday season, retailer-defined time periods for children returning to school, and marketing-company-defined time periods, e.g., around Thanksgiving. Thus, the holiday time period means a time period associated with a holiday as defined either by a retailer or by the marketing company.

Finally, the marketing company database contains fields corresponding to a set of customer loyalty scores. The loyalty scores are computed from at least one of the following sets of data contained in the marketing company database: household personal data, estimated household spending, actual household spending, and actual household frequency data.

The invention may also be defined in terms of a method for computing loyalty scores and generating targeted purchasing incentives at the household level based upon a household's purchase history at the retailer and other household personal/demographic data. This method preferably comprises the steps of (1) requesting POS purchasing data for a given time period from the given retailer; (2) receiving the POS purchasing data for the given time period from the given retailer; (3) sorting the POS records for those belonging to frequent shopper card holders and compiling a list of corresponding frequent shopper card numbers; (4) requesting the names and addresses of the frequent shopper card holders from the retailer computer system; (5) receiving the names and addresses of the frequent shopper card holders from the retailer computer system; (6) aggregating the POS purchasing data into frequency of purchase and total monetary amount spent by a household in a product category/time period; (7) combining records corresponding to multiple frequent shopper card holders of the same household; (8) discarding records belonging to very infrequent shoppers; (9) requesting personal data on each household from the data company computer system; (10) receiving personal data on each household from the data company computer system; (11) transmitting to the data company computer a list of household names and addresses; (12) receiving block group data from the data company computer system corresponding to estimates of total spending levels in various merchandising categories/time periods for each of the various block groups; (13) estimating, using various models and the block group and personal data, the total spending levels of each household in each of several product categories/time periods; (14) computing a set of loyalty scores for each household using various rules applied to the data fields in the marketing company database; (15) generating targeted household purchasing incentives or more general marketing/merchandising recommendations using the loyalty scores; and (16) transmitting the purchasing incentives and/or marketing recommendations to the retailer or manufacturer or consumer in the store, at home, online, or via any other method of communication.

In addition, the method may include analyzing shopping patterns to identify the frequent shopper card number to which a non-frequent-shopper-card POS data record corresponds.

In one aspect, the inventor provides a computer system, program product, and computer implement method comprising means or steps for determining a first household's actual first merchandise category spending level in a first merchandise category in at least one store of a retail chain; determining said first household's estimated first merchandise category total spending level in said first merchandise category; and computing at least one first household first merchandise category loyalty score for said first household as a function of at least said actual first merchandise category spending level and said estimated first merchandise category total spending level.

In one aspect, the invention provides a computer database management system including a database storing actual first merchandise category spending level data and estimated first merchandise category total spending level data in association with household identifications; and code for calculating relationships between said actual first merchandise category spending level data and said estimated first merchandise category total spending level data.

In one aspect, the inventor provides a computer system, program product, and computer implement method comprising means or steps for a marketing company computer system receiving POS shopping history data for a given time period from a retailer computer system; said marketing company computer system requesting personal data from at least one of a data company computer system and said retailer computer system for households corresponding to name and address data; said marketing company computer system receiving personal data corresponding to said name and address data from at least one of said data company computer system and said retailer computer system; said marketing company computer system requesting block group data from the data company computer system that includes for block groups for households in the marketing company database; said marketing company computer system receiving block group data from the data company computer system; said marketing company computer system identifying a sets of block group data to which each household corresponds; said marketing company computer system estimating spending for households in said marketing company database using block group data to which each household belong; and said marketing company computer system computing a set of loyalty scores for households using rules stored in the marketing company database.

Other aspects and advantages of the invention will become apparent from the following more detailed description, taken in conjunction with the accompanying drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of an embodiment of the computer network system of the present invention in which a marketing company computer system communicates via the Internet with a plurality of retailer computer systems and a data company computer system;

FIG. 2 is a schematic of a database record of a retailer's point-of-sale database illustrating data fields;

FIG. 3 is a schematic of a database record of the marketing company's database showing data fields; and

FIG. 4 is a flowchart of the steps for computing loyalty scores by a method of the present invention.

### DESCRIPTION OF THE PREFERRED EMBODIMENT

Referring now to the drawings, wherein like reference numerals designate identical or corresponding parts throughout the several views, the present invention will be described.

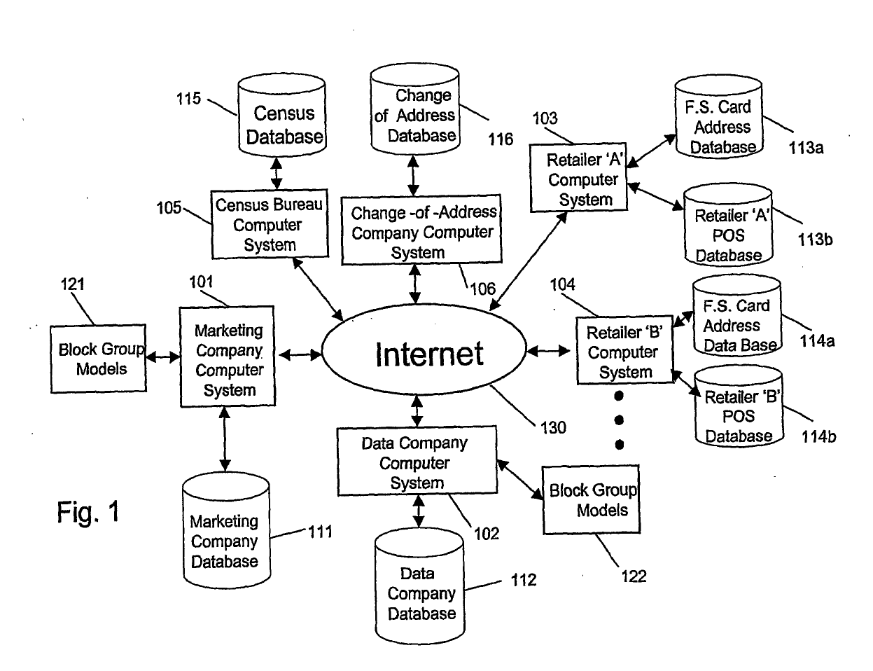

FIG. 1 shows a network architecture in which a marketing company computer system 101 is associated with database 111 and a set of block group models 121. System 101 is connected to the Internet 130. Retailer computer systems 103-104 represent a plurality of retailer computer systems. Each retailer computer system has at least one associated database (113a,114a) for storing POS data and at least one associated database (113b,114b) for storing frequent shopper card numbers and corresponding names and addresses. Data company computer system 102 is connected to the Internet 130 and is associated with database 112 and a set of block group models 122. FIG. 1 also shows two additional computer systems (105-106) and associated databases (115-116) that store change of address and census data, and are connected to the Internet 130. The data lines in FIG. 1 are used to transmit information to or from the respective computer systems via the Internet 130. While multiple retailer systems are shown in FIG. 1, it is to be understood that loyalty scores are preferably determined for a customer of a particular retailer based upon data in customer records obtain from that retailer's store or stores.

Each computer system 101-106 may consist of a plurality of computers communicating via a local-area network. Each computer includes a CPU that carries out a variety of processing and control operations according to computer programs, an I/O unit that transmits data to and from a variety of peripheral devices, and a memory in which computer programs are stored and data obtained in the course of processing are temporarily registered. Each computer preferably further includes an input device used to input, for example, an instruction from a user and a monitor on which data are displayed. Additionally, the retailer computer systems may include a plurality of POS cash registers, a POS controller, and a plurality of coupon printers, for the printing of POS purchasing incentives.

Alternative embodiments have the block group models associated with only one of the computer systems 101, 112. The Internet 130 may be replaced in part or in whole by direct connections or non-public networks.

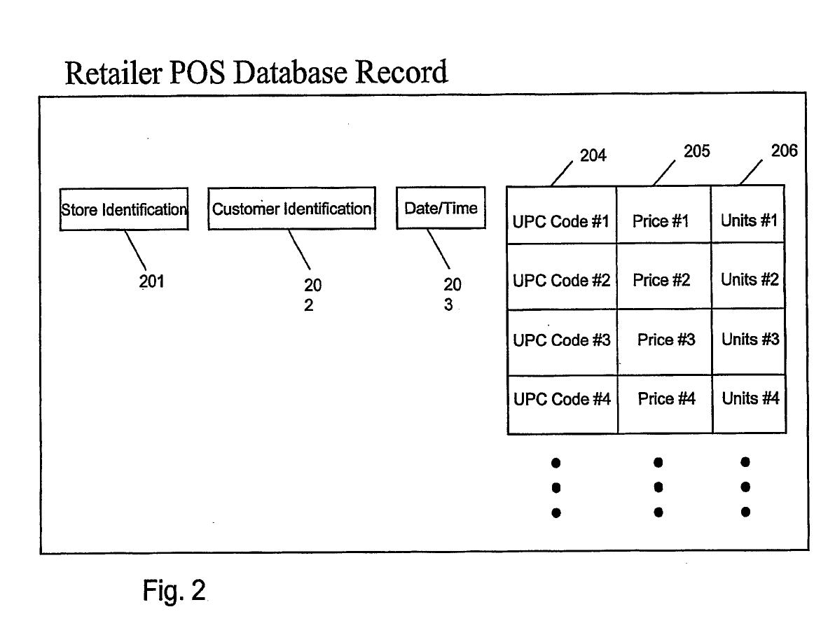

FIG. 2 shows data fields in a preferred record format in the retailer POS database. Each record preferably contains a store identification field 201, one or more customer identification fields 202, one or more date and time fields 203 (e.g., purchase transaction dates), a set of UPC fields 204, with corresponding price fields 205 and corresponding number-of-units fields 206. The customer identification field 202 preferably comprises a frequent shopper card number, but it may comprise part or all of other identifying information including check and credit card numbers, or biographic data such as fingerprint or facial data. Database fields 204-206 contain at least one set of data corresponding to the UPC, price, and number of units of the item(s) purchased, depending on the number of items purchased by the customer. Other additional data fields may be included in the retailer database, such as household association and cumulative individual household transaction data on an item by item, category by category, and total currency basis.

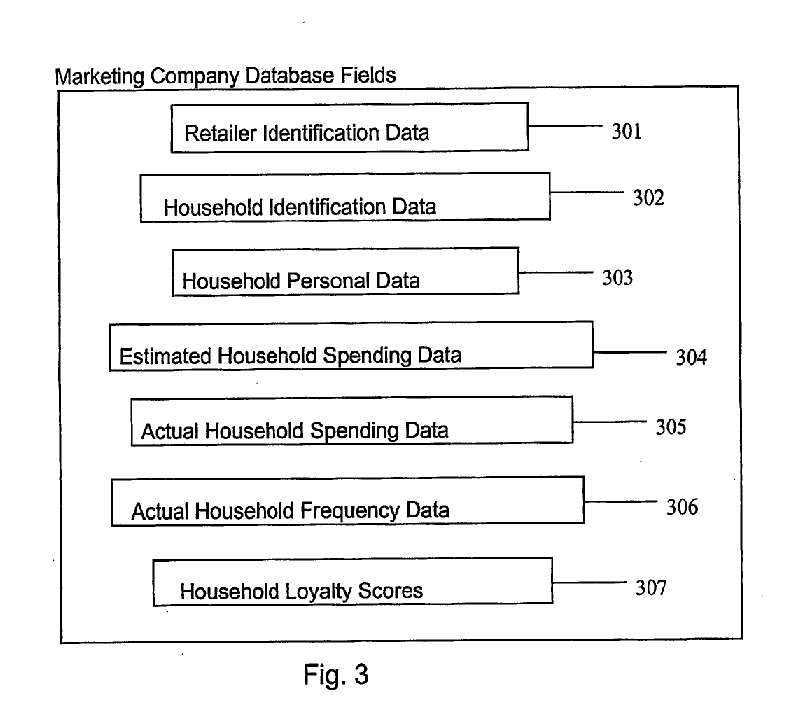

FIG. 3 shows data fields in a preferred record format in the marketing company database. Field 301 contains a unique retailer identifier. The household identification fields 302 preferably contain the head of household name and address, frequent shopper card number, and the associated block group identifier.

The household personal data fields 303 contain personal data such as income level and education level. In the preferred embodiment, the list of household personal data 303 includes home owner/renter status, education level, family type, number in household, number of children, age of children, number in household over 65 years old, age of head of household, income level, number of registered vehicles, ethnic code, household latitude, and household longitude.

The estimated household spending data fields 304 contains the spending data associated with the block group data. The preferred list of block group data fields is spending at or on: grocery stores; eating places; drinking places; drug and proprietary stores; mass merchandisers; clubs; convenience stores; gasoline service stations; beer and ale at home; whiskey at home; wine at home; other alcoholic beverages at home; beer and ale away from home; wine away from home; other alcoholic beverages away from home; alcoholic beverages at restaurants, etc.; cereals; rice; pasta, cornmeal/other cereal products; flour/prepared flour mixes; cookies; crackers; bread and bakery products; canned fish and shellfish; frozen fish and shellfish; fresh fish and shellfish; meats; poultry; frozen juices; other juices; fresh fruits and vegetables; frozen fruits and vegetables; canned fruits and vegetables; other vegetables; eggs; fresh whole milk of all types; cream; butter and margarine; cheese; ice cream and related products; other fresh milk and cream; candy and chewing gum; jams, jellies, and preserves; sugar and artificial sweeteners; fats and oil products; non-dairy cream/imitation milk; peanut butter; coffee; non-carbonated beverages; carbonated beverages; tea; canned and packaged soup; frozen meals; frozen/preparation food other than meals; potato chips and other snacks; nuts; salt/other seasonings and spices; sauces and gravies; prepared salads; baby food; misc prepared foods; condiments; lunch; dinner; snacks and non-alcoholic beverage; breakfast and brunch; catered affairs; food/goods/beverages-grocery stores; food/non-alcoholic beverages-conventional store; food/non-alcoholic beverages-grocery store; food/non-alcoholic beverages on trips; nonprescription drugs; vitamins and vitamin supplements; prescription drugs; topicals and dressings; soaps and detergents; other laundry/cleaning products; paper towels/napkins/toilet tissue; miscellaneous household products; hair care products; non-electric articles for the hair; oral hygiene products, articles; shaving needs; cosmetics, perfume, bath prep; deodorant/feminine hygiene misc. personal care; pet-purchase/supplies/medicine; pet food; film; film processing; books not through book clubs; newspapers; magazines; cigarettes; cigars/pipes/other tobacco products; women's hosiery; men's hosiery; and infants' undergarments. A complete list of the personal data fields and the block group data fields that could be used by the marketing company computer system is given in the Appendix.

In FIG. 3, the actual household spending data fields 305 contain aggregate purchasing data derived from the retailer POS shopping history data. The actual household spending data fields 305 contained in the marketing company database are amounts spent in each of several predefined time periods on each of the following product categories: baby food, baking mixes, baking needs, candy, cereal, cocoa mix & milk modifiers, adult nutritional drinks & bars, coffee, condiments & sauces, cookies, crackers/snacks, croutons/stuffing mixes/snack items, desserts, diet/healthy foods, fish, canned, flour, fruit, canned, fruit, dried, gum, household cleaning compounds, household supplies, jams, jellies, spreads, shelf stable vegetable & juice, juice drinks, laundry supplies, pasta-dry/frozen, meat, canned, milk, canned & powdered, paper products-general, disposable baby diapers, bath & facial tissues, paper towels, napkins, pet food, pickles & relishes, shelf stable prepared foods, salad dressings & mayonnaise, salt, seasonings & spices, shortening & oils, snacks, soaps hand & bath, soaps & detergents, soft drinks & mixes, water/tang, soup, sugar, syrups & molasses, tea, vegetables, canned & dried, refrigerated & frozen toppings, frozen baked goods, frozen chicken/poultry, frozen juice & drinks, frozen potatoes/onion rings, frozen prepared food & pot pies, frozen vegetables/fruit, frozen breakfast food, frozen novelties & ice cream, cheese, yogurt, lunch meats/frankfurters etc., margarine & butter, refrigerated cookies & rolls, refrigerated salads/pasta, misc. refrigerated foods, malted beverages & wine, pie shells, baby needs, deodorants, first aid, hair care needs, oral hygiene, proprietary remedies, proprietary remedies-children, shaving needs, skin care aids, women's hosiery, magazines, books & records, tobacco, service deli, distilled spirits, beauty aids, greeting cards, coupon redemptions, all outside services except coupon redemptions, miscellaneous, toys, contraceptives, pregnancy test kits, produce, refrigerated juices, milk/eggs, bagels, toaster pastries/tarts, feminine hygiene, pediatrics/nutritional bars/water, cereal bars, incontinence pads, children's frozen prepared food, children's yogurt, children's cereal, fruit snacks, private label x milk/eggs/bread/rolls, premium private label x milk/eggs/bread/rolls, coffee creamers, food storage, frozen novelties children's/juice/ice, lunch combinations, rice, pet supplies/litter, men's socks, fresh fish/seafood, frozen fish/seafood, refrigerated meats, refrigerated poultry, bread/rolls-fresh, and total dollars spent.

Note that the actual household spending data fields 305 contained in the marketing company database include all of the above-mentioned (more than 100) product categories for each of several predefined time periods. Thus, there are actually many more than just those listed above. For example, actual spending in each category during the Christmas season, actual spending in each category in January, actual spending in each category in February, etc.

The actual household frequency data fields 306 contained in the marketing company database include the number of purchases during each of several predefined time periods on each of the product categories corresponding to the actual household spending data fields 305, as listed above. Similar to the actual household spending data 305, the actual household frequency data is derived from the retailer's POS shopping history data.

The loyalty score fields 307 each contain a measure of customer loyalty to a given retailer or manufacturer. For example, a loyalty score field may store data indicating the ratio of the total amount spent at a retailer in a given period of time by a household to the estimated total amount spent at all similar retailers in the same time period by the household, preferably derived from models using the block group data.

Other loyalty scores that can be computed focus on particular purchasing categories and factor in personal/demographic data. For example, a score for households having children, but not buying baby products; a score for the amount of health and beauty aids purchased; a score for the amount of purchasing of private labels; a score for the purchasing of convenience products (milk, bread, soda, etc.); a score for the number of different categories purchased in a given time period; a score to measure central store spending vs. perimeter store spending (bakery, meat, floral, etc.); a score for profitability (buying high versus low margin categories); a score based on back-to-school spending; a score based on the amount of coupons used; a score based on the distance from a household's residence to the retailer; a score based on the distance from a household's residence to the retailer's competitors; a score for the amount of children's products purchased; a score based on the pattern of categories purchased; a score based on the number of holidays shopped per year by the household; scores based on the composition of the household (e.g., having teenagers or pre-teens); and a score based on total overall spending.

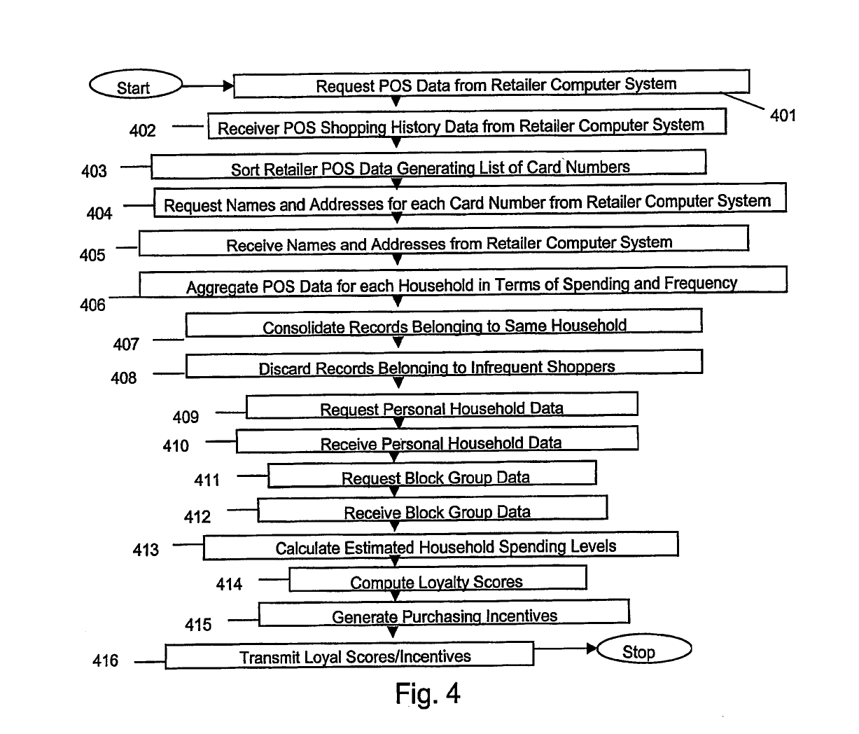

FIG. 4 lists the steps in the method of computing customer loyalty scores for a given retailer or manufacturer in the preferred embodiment of the present invention.

In step 401, the marketing company computer system requests POS shopping history data for a given time period from a given retailer. This data preferably includes the fields shown in FIG. 2.

In step 402, the marketing company computer system receives the POS shopping history data for the given time period from the retailer.

In steps 403-408, the marketing company computer system screens the retailer POS data and converts it into a form consistent with its associated database 111. These steps may be performed in an order different than presented below.

First, in step 403, the marketing company computer system may determine to ignore those records not associated with a frequent shopper card. Additionally, the marketing company computer system compiles a list of the frequent shopper card numbers from the retailer POS data.

Next, in step 404, for each frequent shopper card number obtained in step 403, the marketing company computer system requests the corresponding name and address from the retailer computer system.

In step 405, the retailer computer system receives the frequent shopper card information, associates the name and address information with the frequent shopper card information, and transmits all the information to the marketing company computer system.

In step 406, the retailer POS data belonging to each frequent shopper card holder is aggregated into the total monetary amount spent in a product category/time period for each of the actual household spending data fields 305. Also during this step, the retailer POS data belonging to each frequent shopper card holder is aggregated into the number of purchases in a product category/time period for each of the actual household frequency data fields 306.

In step 407, records corresponding to frequent shopper card holders associated with the same household (as indicated, for example, by identical address data) are consolidated. The consolidation results in a single record indicating the quantity of items by product category, and the quantity of different brands of items in each category, purchased in association with the frequent shopper card number for the specified period of time.

Finally, in step 408, records belonging to infrequent shoppers are discarded. In this context, an infrequent shopper means a shopper that has not met either an item quantity or currency value specification or some combination of both in a specified time period as defined by the shopper's record in the marketing company database.

In step 409, the marketing company computer system requests personal data corresponding to the fields 303 from the data company computer system for each household in its database.

In step 410, the marketing company computer system receives the personal data corresponding to the fields 303 from the data company computer system for each household in its database. If personal data for some households in the marketing company database is missing due to its unavailability from the data company, a limited number of loyalty scores may still be computed. However, the marketing company computer system may also receive certain personal data from the retailer computer system 103, 104.

In step 411, using a list of household names and addresses, the marketing company computer system requests block group data from the data company computer system that includes every household in the marketing company database. The block group data includes estimates of total spending levels on various merchandising categories, such as spending at grocery stores, spending at drug stores, spending on cereal, spending on milk, etc. for each of the various block groups. Block group data is collected in the data company computer system's database 112 in various ways and from various sources including the census bureau and national change-of-address databases. The household composition of each block group is defined by the census bureau.

In step 412, the marketing company computer system receives block group data for each household. Alternative sources of household data may be used instead of block group data. For example, the consumer's actual total spending in a product category may be available, and the marketing company computer system may use that data.

The block group data is used in step 413, in various models, to estimate spending for each household in the marketing company database. The results are stored in the estimated household spending data fields 304. In producing these spending estimates, the marketing company computer system must identify the set of block group data to which each household corresponds by using each household's block group identifier (in 302). Additionally, household features, as determined by the personal household data 303, are used as part of these models to produce more accurate household spending estimates.

One example of a model used in step 413 specifies dividing the aggregate spending level of the block group for that category by the number of households in the block group to determine estimated household spending for that category for all households associated with that block group. Of course, such a model ignores information which may be stored in the marketing company database 111 or the data company database 112 for a household that may be very pertinent to estimating that household's spending level on a given merchandising category. For example, for a household with no children, an estimate of spending on baby food, based upon a model that does not account for the number of children in the household is statistically less accurate than a model accounting for the number of children in the household. The invention may use this category specific data, when it exists to model the household's spending as some value scaled to the average of the block group data.

In an alternative embodiment, the data company computer system may translate some of the block group data into estimated household spending estimates and transmit this data to the marketing company, along with the remaining untranslated block group data.

In step 414, having received all data from outside sources and processed it into appropriate forms, the marketing company computer system computes a set of loyalty scores 307 for each household using various rules applied to the data fields 303-306. For example, a primary loyalty score will be the household's total dollars spent at the retailer (as determined by the retailer POS data) divided by an estimate of the household's total expenditure at all similar retailers (as derived from models using the block group data).

An example of a loyalty score is an indicator of the fraction of its children' products that the household purchases at the retailer, given an indication that the household has children. Another example of a loyalty score is an indication that the household purchases a relatively large quantity of convenience items in the store compared to the household's estimated total purchases on grocery items. Another example of a loyalty score is an indication that the household purchases a relatively large quantity of convenience items at the retailer compared to an average quantity of convenience items purchased by other customers at the retailer. Another loyalty score is a measure of a “declining shopper.” This is a measure of the change in total dollars spent by a household at the retailer.

In step 415, the marketing company computer system uses the loyalty scores to generate targeted household purchasing incentives or more general marketing/merchandising recommendations for transmission to the retailer or manufacturer in step 416. For example, the marketing company system may compile and transmit a list of the names and addresses of households with small children who had very low loyalty to the retailer's baby food merchandise, yet had high loyalty to the retailer on the basis of total expenditures among similar retailers. The marketing company or the retailer may transmit incentives determined by this invention via postal mail, email, hand delivery at a POS terminal during a purchase transaction, as part of a paper or electronic coupon book, or via electronic storage in a hand held electronic device, such as a personal digital assistant. In an alternative embodiment, the marketing company computer system would not generate purchasing incentives or marketing recommendations from the loyalty scores, but rather transmit the loyal scores to the retailer or manufacturer directly.

Examples of using loyalty scores to generate targeted incentives include (a) providing a high-loyalty household with a coupon of low value to purchase products in the category in which the household has the high loyalty score and (b) providing a household with a low loyalty score in the same category with a high value incentive to purchase products in that category. Another example of using loyalty scores is providing an incentive to a household to shop during a non-holiday season when that consumer has a loyalty score showing that the consumer shops at the store during one or more holiday seasons. Another example of using loyalty scores is providing an incentive to a household to purchase a product geared to teenagers when a loyalty score shows that the consumer has or will shortly have teenagers.

It will be appreciated from the foregoing that the present invention represents a significant advance over other systems and methods for generating purchasing incentives and merchandising recommendations. In particular, the system and method of the invention provide for the generation of targeted purchasing incentives at the household level by utilizing a unique combination of personal/demographic data and shopping history data to compute a new set of detailed loyalty scores. By obtaining such scores, retailers and manufacturers will obtain a better understand of their customers shopping behavior, and can tailor their merchandising, marketing, and promotional efforts accordingly. It will also be appreciated that, although a limited number of embodiments of the invention have been described in detail for purposes of illustration, various modifications may be made without departing from the spirit and scope of the invention. Accordingly, the invention should not be limited except as by the appended claims.

1. A computer implemented method comprising:
determining a first household's actual first merchandise category spending level in a first merchandise category in at least one store of a retail chain;
determining said first household's estimated first merchandise category total spending level in said first merchandise category;
computing at least one first household first merchandise category loyalty score for said first household as a function of at least said first household's actual first merchandise category spending level and said first household's estimated first merchandise category total spending level.

2. The method of claim 1 further comprising:
determining said first household's actual second merchandise category spending level in a second merchandise category in at least one store of said retail chain;
determining said first household's estimated second merchandise category total spending level in said second merchandise category;
computing at least one first household second merchandise category loyalty score for said first household as a function of at least said first household's actual second merchandise category spending level and said first household's estimated second merchandise category total spending.

3. The method of claim 1 further comprising:
determining a second household's actual first merchandise category spending level in a first merchandise category in at least one store of a retail chain;
determining said second household's estimated first merchandise category total spending level in said first merchandise category; and
computing at least one second household first merchandise category loyalty score for said second household as a function of at least said second household's actual first merchandise category spending level and said second household's estimated first merchandise category total spending level.

4. The method of claim 1 further comprising transmitting at least one first household's first merchandise category loyalty score and identification of said first household to a manufacturer computer system.

5. The method of claim 1 further comprising depending issuing an incentive offer to a household based upon a value of said at least one first household first merchandise category loyalty score.

6. The method of claim 1 further comprising depending terms of an incentive offer to a household based upon a value of said at least one first household's first merchandise category loyalty score.

7. The method of claim 1 further comprising depending both issuing and terms of an incentive offer to a household based upon a value of said at least one first household first merchandise category loyalty score.

8. The method of claim 1 wherein said determining said first household's estimated first merchandise category total spending level in said first merchandise category comprises using block data.

9. The method of claim 1 wherein said at least one first household first merchandise category loyalty score defines a measure of customer loyalty to a given retailer or manufacturer.

10. The method of claim 1 further comprising transmitting shopping history data from a retailer computer system to a marketing company computer system.

11. The method of claim 1 further comprising transmitting said at least one first household first merchandise category loyalty score and identification of said first household to a retailer computer system.

12. The method of claim 1 further comprising determining, based at least in part upon a value of said at least one first household first merchandise category loyalty score, whether to transmit to a household an incentive to purchase a good or service.

13. The method of claim 12 wherein terms of said incentive depend upon a loyalty score associated with said household.

14. A computer system, comprising:
means for determining a first household's actual first merchandise category spending level in a first merchandise category in at least one store of a retail chain;
means for determining said first household's estimated first merchandise category total spending level in said first merchandise category;
means for computing at least one first household first merchandise category loyalty score for said first household as a function of at least said first household's actual first merchandise category spending level and said first household's estimated first merchandise category total spending level.

15. The system of claim 14 further comprising:
means for determining said first household's actual second merchandise category spending level in a second merchandise category in at least one store of said retail chain;
means for determining said first household's estimated second merchandise category total spending level in said second merchandise category;
means for computing at least one first household second merchandise category loyalty score for said first household as a function of at least said first household's actual second merchandise category spending level and said first household's estimated second merchandise category total spending level.

16. The system of claim 14 further comprising:
means for determining a second household's actual first merchandise category spending level in a first merchandise category in at least one store of a retail chain;
means for determining said second household's estimated first merchandise category total spending level in said first merchandise category; and
means for computing at least second household one first merchandise category loyalty score for said second household as a function of at least said second household's actual first merchandise category spending level and said second household's estimated first merchandise category total spending.

17. The system of claim 14 further comprising means for transmitting at least one first household first merchandise category loyalty score and identification of said first household to a manufacturer computer system.

18. The system of claim 14 further comprising means for depending issuing an incentive offer to a household based upon a value of said at least one first household first merchandise category loyalty score.

19. The system of claim 14 further comprising means for depending terms of an incentive offer to a household based upon a value of said at least one first household first merchandise category loyalty score.

20. The system of claim 14 further comprising means for depending both issuing and terms of an incentive offer to a household based upon a value of said at least one first household first merchandise category loyalty score.

21. The system of claim 14 wherein said means for determining said first household's estimated first merchandise category total spending level in said first merchandise category comprises using block data.

22. The system of claim 14 wherein said at least one first household first merchandise category loyalty score defines a measure of customer loyalty to a given retailer or manufacturer.

23. The system of claim 14 further comprising means for transmitting shopping history data from a retailer computer system to a marketing company computer system.

24. The system of claim 14 further comprising means for transmitting said at least one first household first merchandise category loyalty score and identification of said first household to a retailer computer system.

25. The system of claim 14 further comprising means for determining, based at least in part upon a value of said at least one first household first merchandise category loyalty score, whether to transmit to a household an incentive to purchase a good or service.

26. The system of claim 25 wherein terms of said incentive depends upon at least one loyalty score associated with said household.

27. A computer database management system including a database storing:
actual first merchandise category spending level data and estimated first merchandise category total spending level data in association with household identifications; and
code for calculating relationships between said actual first merchandise category spending level data and said estimated first merchandise category total spending level data.

28. The system of claim 27 wherein said relationships define loyalty scores.

29. A computer program product embedded in a computer readable medium storing computer code for implementing the following instructions:
determining a first household's actual first merchandise category spending level in a first merchandise category in at least one store of a retail chain;
determining said first household's estimated first merchandise category total spending level in said first merchandise category; and
computing at least one first household first merchandise category loyalty score for said first household as a function of at least said first household's actual first merchandise category spending level and said first household's estimated first merchandise category total spending level.

30. A product of claim 29 wherein said first merchandise category loyalty score is a measure of loyalty of a household to said store with respect to purchases of products in said first merchandise category.

31. A computer implemented method, comprising:
a marketing company computer system receiving POS shopping history data for a given time period from a retailer computer system;
said marketing company computer system requesting personal data from at least one of a data company computer system and said retailer computer system for households corresponding to name and address data;
said marketing company computer system receiving personal data corresponding to said name and address data from at least one of said data company computer system and said retailer computer system;
said marketing company computer system requesting block group data that includes for block groups for households in a marketing company database from said data company computer system;
said marketing company computer system receiving block group data from said data company computer system;
said marketing company computer system identifying a set of block group data to which each household corresponds;
said marketing company computer system estimating spending for households in said marketing company database using block group data to which each household corresponds; and
said marketing company computer system computing a set of loyalty scores for households using rules stored in said marketing company database.

32. The method of claim 31 further comprising said marketing company computer system using said loyalty scores to generate at least one of targeted household purchasing incentives and general marketing/merchandising recommendations.

33. The method of claim 32 further comprising said marketing company computer system transmitting at least one of said targeted household purchasing incentives and general marketing/merchandising recommendations to at least one of a retailer, a manufacturer, and a household.

34. The method of claim 31 further comprising said marketing company computer system requesting POS shopping history data for said given time period from said retailer computer system.

35. The method of claim 32 further comprising said marketing company computer system screening said POS shopping history data and converting said POS shopping history data into a form consistent with a database associated with said marketing company computer system.

36. The method of claim 35 wherein said screening comprises ignoring records not associated with a frequent shopper card identification.

37. The method of claim 35 wherein said screening comprises compiling a list of the frequent shopper card numbers from said POS shopping data.

38. The method of claim 35 wherein said screening comprises requesting from said retailer computer system name and address data corresponding to frequent shopper card numbers in a list.

39. The method of claim 35 wherein said screening comprises aggregating POS shopping history data associated with a frequent shopper card number into (i) total monetary amount spent in a product category/time period and (ii) number of purchases in a product category/time period for actual household spending.

40. The method of claim 31 further comprising said marketing company computer system consolidating into one record records associated with multiple frequent shopper card numbers.

41. The method of claim 31 further comprising said marketing company computer system discarding records that do not meet at least one of an item quantity specification and a currency value specification for purchases in a specified time period.
